(19) United States
(12) Patent Application Publication
(10) Pub. No.: US 2009/0087715 A1
(43) Pub. Date: Apr. 2, 2009

(54) Polymer electrolyte membrane and membrane-electrode assembly for fuel cell and fuel cell system including same

(76) Inventor: Moon-Yup Jang, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/285,001

(22) Filed: Sep. 26, 2008

(30) Foreign Application Priority Data
Sep. 28, 2007 (KR) 10-2007-0097912

(51) Int. Cl. H01M 8/10

(52) U.S. Cl. 429/33

(57) ABSTRACT

A polymer electrolyte membrane is provided with a cation exchange resin and a mineral additive including an exfoliated layered silicic acid-based clay. The polymer electrolyte membrane includes the nano-sized exfoliated mineral additive dispersed in the polymer electrolyte membrane, and thereby fuel cross-over can be effectively suppressed by the small amount of mineral additive while maintaining excellent ion conductivity and mechanical properties.

### CLAIM OF PRIORITY

This application makes reference to, incorporates the same herein, and claims all benefits accruing under 35 U.S.C. §119 from an application earlier filed in the Korean Intellectual Property Office on Sep. 28, 2007 and there duly assigned Serial No. 10-2007-0097912.

### BACKGROUND OF THE INVENTION

1. Field of the Invention

The present invention relates to a polymer electrolyte membrane for a fuel cell, and a membrane-electrode assembly and a fuel cell system including the polymer electrolyte membrane. More particularly, the present invention relates to a polymer electrolyte membrane for inhibiting fuel cross-over, and a membrane-electrode assembly and a fuel cell system including the polymer electrolyte membrane.

2. Description of the Related Art

A fuel cell is a power generation system for producing electrical energy through an electrochemical redox reaction of an oxidant and hydrogen in a hydrocarbon-based material such as methanol, ethanol, or natural gas.

Such a fuel cell is a clean energy source that can replace fossil fuels. The fuel cell includes a stack composed of unit cells and produces various ranges of power. Since the fuel cell has four to ten times higher energy density than that of a small lithium battery, the fuel cell has been highlighted as a small portable power source.

Representative exemplary fuel cells include a polymer electrolyte membrane fuel cell (PEMFC) and a direct oxidation fuel cell (DOFC). The direct oxidation fuel cell includes a direct methanol fuel cell, which uses methanol as a fuel.

The polymer electrolyte fuel cell has an advantage of a high energy density, but the polymer electrolyte fuel cell also has problems in the need to carefully handle hydrogen gas and the requirement of accessory facilities such as a fuel reforming processor for reforming methane or methanol, natural gas, and the like, in order to produce hydrogen as the fuel gas.

On the contrary, a direct oxidation fuel cell has a lower energy density than that of the polymer electrolyte fuel cell, but the direct oxidation fuel cell has the advantages of easy handling of a fuel, being capable of operating at room temperature due to its low operation temperature, and no need for additional fuel reforming processors.

In the above fuel cell, the stack that generates electricity substantially includes several to scores of unit cells stacked in multiple layers, and each unit cell is formed of a membrane-electrode assembly (MEA) and a separator (also referred to as a bipolar plate). The membrane-electrode assembly has an anode (also referred to as a fuel electrode or an oxidation electrode) and a cathode (also referred to as an air electrode or a reduction electrode) attached to each other with an electrolyte membrane disposed between them.

### SUMMARY OF THE INVENTION

It is an object of the present invention to provide an improved polymer electrolyte membrane and an improved fuel cell.

It is another object of the present invention to provide a polymer electrolyte membrane having excellent proton conductivity and inhibition properties of fuel cross-over.

It is still another object of the present invention to provide a membrane-electrode assembly including the polymer electrolyte membrane.

It is a further object of the present invention to provide a fuel cell system including the polymer electrolyte membrane.

According to one embodiment of the principles of the present invention, a polymer electrolyte membrane is constructed with a cation exchange resin, and a mineral additive including an exfoliated layered silicic acid-based clay.

The mineral additive includes at least one selected from the group consisting of kanemite, makatite, octasilicate, kenyatite, and mixtures thereof.

The mineral additive is dispersed in a nano-sized plate-shaped structure in a polymer electrolyte membrane. The mineral additive has an aspect ratio ranging from 200 to 2500.

The mineral additive is present in an amount of 0.5 to 3 parts by weight based on 100 parts by weight of the cation exchange resin.

According to another embodiment of the principles of the present invention, a method for manufacturing a polymer electrolyte membrane includes preparing a mineral additive composition by adding a mineral additive to an organic solvent, agitating the mineral additive composition to exfoliate the mineral additive, separating the mineral additive from the mineral additive composition; and mixing the separated mineral additive and a cation exchange resin.

The agitating is performed at a speed of 300 to 2000 rpm.

The mineral additive is used in an amount of 5 to 10 parts by weight based on 100 parts by weight of an organic solvent. The organic solvent includes at least one selected from the group consisting of alcohols such as 1-butanol, 2-butanol, and ethanol, a furan-based solvent such as tetrahydrofuran (THF), and mixtures thereof.

According to yet another embodiment of the principles of the present invention, a membrane-electrode assembly for a fuel cell includes an anode and a cathode facing each other, and a polymer electrolyte membrane interposed therebetween. The polymer electrolyte membrane includes a cation exchange resin and a mineral additive including an exfoliated layered silicic acid-based clay.

According to still another embodiment of the principles of the present invention, provided is a fuel cell system including an electricity generating element, a fuel supplier, and an oxidant supplier.

The electricity generating element includes a membrane-electrode assembly and separators arranged at each side thereof. The membrane-electrode assembly includes an anode and a cathode facing each other, and the above polymer electrolyte membrane interposed therebetween. The fuel supplier plays a role of supplying the electricity generating element with a fuel including hydrogen, and the oxidant supplier plays a role of supplying the electricity generating element with an oxidant.

The polymer electrolyte membrane includes a nano-sized exfoliated mineral additive dispersed in the polymer electrolyte membrane, and thereby fuel cross-over could be effectively suppressed by a small amount of mineral additive while maintaining excellent ion conductivity and mechanical properties.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view showing a non-exfoliated mineral additive in a polymer electrolyte membrane;

FIG. 2 is a schematic view showing an exfoliated mineral additive in a polymer electrolyte membrane according to one embodiment of the principles of the present invention;

FIG. 3 is a graph showing X-ray diffraction peaks of polymer electrolyte membranes according to Examples 1 and 2, and Comparative Examples 1 and 2; and

FIG. 4 schematically shows a fuel cell system according to one embodiment of the present invention.

### DETAILED DESCRIPTION OF THE EMBODIMENTS

A fuel cell causes problems that fuel is wasted due to a cross-over phenomenon in which un-reacted fuel gas and liquid permeate through a polymer membrane, thus battery performance is degenerated. Particularly, such cross-over phenomenon is more frequently caused when methanol is used as a fuel. This is because methanol has a similar size and polarity with water, so un-oxidized methanol is simultaneously permeated as a liquid or in a gaseous phase together with water through a hydrated proton conductive polymer membrane to reach the cathode. After reaching the cathode, the un-oxidized methanol is oxidized to undesirably deteriorate the performance of the fuel cell.

If the polymer electrolyte membrane is made from a perfluorosulfonic acid resin membrane, the polymer electrolyte membrane should have a thickness of approximately 175 μm or more in order to prevent the fuel cell cross-over; however, the electrolyte membrane conductivity (conductance) is decreased although the dimensional stability and the mechanical property are improved when the thickness of the membrane is increased.

In order to prevent the fuel cell cross-over, it has been suggested to employ a silicic acid-based clay in which a plurality of layers of the silicic acid-based clay are laminated in the polymer electrolyte membrane. In this case, a lot of the laminated silicic acid-based clay is added into the polymer electrolyte membrane, and therefore the conductivity of the polymer electrolyte membrane is deteriorated.

The present invention relates to a polymer electrolyte membrane for a fuel cell in order to solve these problems.

The polymer electrolyte membrane according to one embodiment of the principles of the present invention includes a cation exchange resin and a mineral additive including an exfoliated layered silicic acid-based clay.

The mineral additive includes at least one silicic acid-based clay selected from the group consisting of kanemite, makatite, octasilicate, kenyatite, and mixtures thereof.

The mineral additive is exfoliated in a nano-size, and is dispersed in a single-layered structure in a polymer electrolyte membrane.

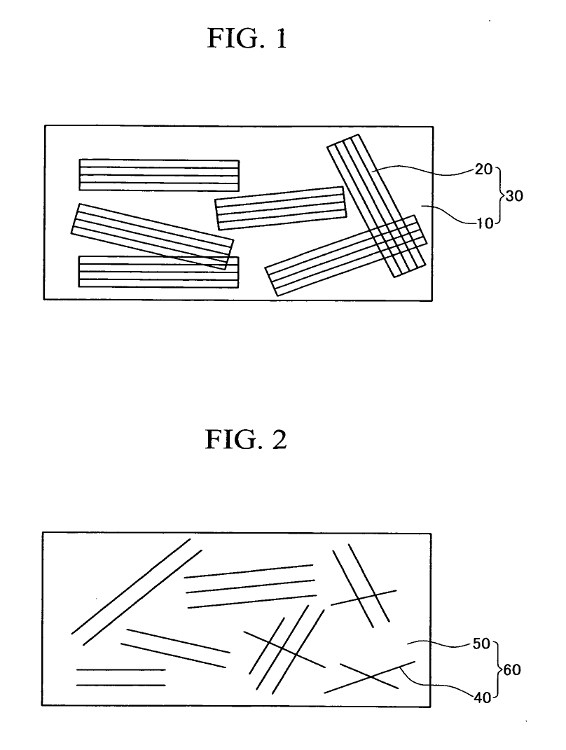

FIG. 1 is a schematic view showing a polymer electrolyte membrane 30 where a non-exfoliated mineral additive 20 is dispersed in a polymer matrix 10. As shown in FIG. 1, mineral additive 20 is not exfoliated in polymer matrix 10 and a large amount of mineral additive 20 is present. The large amount of mineral additive 20 decreases the proton conductivity of the polymer electrolyte membrane.

FIG. 2 is a schematic view showing a polymer electrolyte membrane 60 according to one embodiment of the principles of the present invention where an exfoliated mineral additive 40 is dispersed in a polymer matrix 50.

As shown in FIG. 2, a plurality of layers of mineral additive 40 are exfoliated in a nano-size, and are dispersed in a single-layered structure in a polymer electrolyte membrane. Even if the fuel permeates through polymer electrolyte membrane 60, the passage of the fuel through polymer electrolyte membrane 60 is extended as shown in FIG. 2 since mineral additive 40 is dispersed, so the cross-over phenomenon in which the fuel is permeated through the polymer electrolyte membrane and transferred to the cathode is more effectively suppressed.

According to the present invention, it is possible to suppress the fuel cross-over as well as to maintain the proton conductivity by adding the mineral additive in a small amount to the polymer electrolyte membrane since the suppression efficiency of the cross-over is increased.

That is, the mineral additive is added in an amount of approximately 0.5 to 3.0 parts by weight, which is much smaller than the contemporary amount of 20 to 50 parts by weight, based on 100 parts by weight of a proton conductive cation exchange resin. According to another embodiment of the principles of the present invention, the mineral additive is added at approximately 1 to 2 parts by weight based on 100 parts by weight of a proton conductive cation exchange resin. When the mineral additive is added at more than the range as specified above, the proton conductivity is decreased. On the other hand, when the mineral additive is added at less than the range, and the cation exchange resin is present in more than the range, the fuel cross-over amount is increased.

The mineral additive may have an aspect ratio (ratio of the shorter axis and the longer axis) ranging from approximable 200 to 2500. According to another embodiment of the principles of the present intention, the aspect ratio of the mineral additive ranges from approximable 500 to 2000. According to a further embodiment of the principles of the present intention, the aspect ratio of the mineral additive ranges from approximable 1000 to 1500. When the mineral additive has an aspect ratio of more than 2500, the mineral additive may inhibit the proton transfer. On the other hand, when the mineral additive has an aspect ratio of less than 200, the fuel cross-over amount is increased.

Furthermore, mineral additives having aspect ratios of 600, 700, 800, 900, or 1100 may be appropriate.

The mineral additive including multi-layered silicic acid-based clay is added to an organic solvent and is strongly agitated. When the organic solvent is used, the organic solvent exfoliates the multi-layered silicic acid-based clay by the mechanical agitation process, then the supernatant is separated and then dried to remove the organic solvent, resulting in providing a silicic acid-based clay having a nano-size plate-shaped structure.

The cation exchange resin may be a polymer resin having a cation exchange group selected from the group consisting of a sulfonic acid group, a carboxylic acid group, a phosphoric acid group, a phosphonic acid group, and derivatives thereof at its side chain.

Non-limiting examples of the ion exchange resin including the cation exchange group include at least one proton conductive polymer selected from the group consisting of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, and polyphenylquinoxaline-based polymers. In one embodiment according to the principles of the present invention, the proton conductive polymer is at least one selected from the group consisting of poly(perfluorosulfonic acid) (commercially available NAFION), poly(perfluorocarboxylic acid), a copolymer of tetrafluoroethylene and fluorovinylether having a sulfonic acid group, defluorinated polyetherketone sulfide, aryl ketone, poly[2,2′-(m-phenylene)-5,5′-bibenzimidazole], and poly(2,5-benzimidazole).

The hydrogen (H) in a proton conductive group of the proton conductive polymer side chain can be substituted by Na, K, Li, Cs, or tetrabutylammonium. When the H in the ionic exchange group of the terminal end of the proton-conductive polymer side is substituted with Na or tetrabutylammonium, NaOH or tetrabutylammonium hydroxide may be used, respectively. When the H is substituted with K, Li, or Cs, suitable compounds for the substitutions may be used. A method of substituting H is known in the related art, and therefore is not further described in detail.

Although the polymer electrolyte membrane according to one embodiment is a thin membrane having a thickness of approximately 25 μm to 50 μm, the polymer electrolyte membrane can suppress the fuel cross-over phenomenon, so the fuel cell including the electrolyte membrane can improve output density.

Hereinafter, a method for manufacturing a polymer electrolyte membrane according to one embodiment of the principles of the present invention is described.

A mineral additive having a multi-layered structure, was added to an organic solvent to provide a mineral additive solution. The mineral additive may include a silicic acid-based clay selected from the group consisting of kanemite, makatite, octasilicate, kenyatite, and a mixture thereof. According to another embodiment, the mineral additive is added at approximately 10 to 25 parts by weight based on 100 parts by weight of the organic solvent. When the amount of the mineral additive is less than 10 parts by weight, exfoliated nano-sized plate-shaped layered structure may be broken. When the amount of the mineral additive is more than 25 parts by weight, mineral additives attract each other to aggregate.

The organic solvent for the mineral additive solution may be selected from the group consisting of alcohols such as 1 -butanol, 2-butanol, and ethanol, a furan-based solvent such as tetrahydrofuran (THF), and mixtures thereof.

Subsequently, the mineral additive solution is agitated. After the agitating step, the multi-layered mineral additives are exfoliated to provide a single-layered mineral additive.

The agitation process may be performed at approximately 20° C. to 25° C. for 24 hours.

The agitation speed may range from approximately 300 rpm to 2000 rpm (revolutions per minute). When the agitation speed is higher than 2000 rpm, the nano-sized plate-shaped structure is damaged to form particles. Further, if the agitation speed is less than 300 rpm, nano-sized plate-shaped structure is insufficiently exfoliated.

The mineral additive solution is dried to provide a nano-sized plate-shaped mineral additive.

After the agitation process, the mineral additive solution is allowed to stand for a certain number of hours to precipitate the powders. The precipitated powders are discarded, and the supernatant including the mineral additives in which a plurality of layers are exfoliated is separated.

The mineral additive laminated with a plurality of layers may be provided by purifying a natural mineral additive in accordance with the contemporary, by purchasing a commercially available additive, or by synthesizing one. As an example for synthesizing the mineral additive, kanemite (NaHSi₂O₄(OH)₂.2H₂O) is synthesized as follows.

A silicic acid-based clay material is fired to synthesize sodium silicate. The firing process may be performed at approximately 600° C. to 1000° C. for 20 to 24 hours.

The silicic acid-based clay raw material is selected from the group consisting of a mixture of SiO₂ and Na₂O, and a combination thereof.

The synthesized silicic acid sodium is mixed with water at a weight ratio of approximately 2:8 to 3:7, agitated, and dried to provide a mineral additive including a multi-layered silicic acid-based clay.

The mineral additive in which a plurality of layers are exfoliated and a cation exchange resin are dissolved in an organic solvent to provide a cation exchange resin-mineral additive solution. The amount of mineral additive ranges from approximately 0.5 to 3 parts by weight based on 100 parts by weight of the cation exchange resin. According to another embodiment, the amount of mineral additive ranges from 1 to 2 parts by weight. The fuel cross-over is decreased as well as the high proton conductivity is maintained when the cation exchange resin and the mineral additive are added within the range.

The cation exchange resin is the same as above-mentioned.

For the organic solvent for the cation exchange resin-mineral additive solution, a hydrophobic organic solvent such as dimethylacetate is suitable, but a hydrophilic organic solvent such as alcohol is not suitable. The cation exchange resin has a hydrophilic group, but the mineral additive has a hydrophobic group. This is not preferable since the mineral additive is precipitated when the organic solvent includes a hydrophilic solvent such as alcohol. The hydrophobic organic solvent may include dimethylacetate, dimethylacetamide, dimethylformamide, N-methyl-2-pyrrolidinone, and at least one mixture thereof.

Further, when the commercially available cation exchange resin includes poly(perfluorosulfonic acid), the cation exchange resin is generally dissolved in a mixed solvent of water and 2-propanol. Therefore, it is enforcedly evaporated at room temperature and dissolved in a hydrophobic solvent such as dimethylacetate at about 0.5 to 30 parts by weight to provide a cation exchange resin solution.

The mixing process may be performed at about 50° C. to 100° C. under the mechanical agitation condition. When the mixing process is performed at a temperature of less than 50° C., the mixing process duration is prolonged, and on the other hand, when the mixing process is performed at more than 100° C., the solvent is evaporated and the concentration is not controlled.

The added amount of the mineral additive ranges from 0.5 to 3 parts by weight based on 100 parts by weight of cation exchange resin. According to another embodiment, the mineral additive ranges from 1 to 2 parts by weight. When the amount of mineral additive is less than 0.5 parts by weight, the effect of preventing the fuel cross-over is deteriorated, and on the other hand, when it is more than 3 parts by weight, the polymer electrolyte membrane is too brittle.

The provided solution is formed in a film to provide a polymer electrolyte membrane in accordance with the conventional method.

The membrane-electrode assembly including the above polymer electrolyte membrane includes an anode and a cathode facing each other, and a polymer electrolyte membrane interposed therebetween.

The cathode and anode respectively include an electrode substrate and a catalyst layer.

The catalyst layer includes at least one selected from the group consisting of platinum, ruthenium, osmium, a platinum-ruthenium alloy, a platinum-osmium alloy, a platinum-palladium alloy, a platinum-M alloy, and combinations thereof, where M is a transition element selected from the group consisting of Ga, Ti, V, Cr, Mn, Fe, Co, Ni, Cu, Zn, Sn, Mo, W, Rh, Ru, and combinations thereof. The same catalyst may be used for an anode and a cathode as aforementioned, but a platinum-ruthenium alloy catalyst may be used as an anode catalyst in a direct oxidation fuel cell to prevent catalyst poisoning due to CO generated during the anode reaction. Representative examples of the catalysts include at least one selected from the group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, and Pt/Ru/Sn/W.

The catalysts can be supported on a carbon carrier or not supported as a black type. Suitable carriers include carbon-based materials such as graphite, denka black, ketjen black, acetylene black, carbon nanotubes, carbon nanofiber, carbon nanowire, carbon nanoballs, activated carbon, and so on, or inorganic material particulates such as alumina, silica, zirconia, titania, and so on.

The catalyst layers may include a binder resin to improve their adherence and proton transfer properties.

The binder resin may be a proton conductive polymer resin having a cation exchange group selected from the group consisting of a sulfonic acid group, a carboxylic acid group, a phosphoric acid group, a phosphonic acid group, and derivatives thereof at its side chain. Non-limiting examples of the polymer include at least one proton conductive polymer selected from the group consisting of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly[2,2′-(m-phenylene)-5,5′-bibenzimidazole], and poly(2,5-benzimidazole).

The hydrogen (H) in the ionic exchange group of the terminal end of the proton conductive polymer side chain can be substituted with Na, K, Li, Cs, or tetrabutylammonium. When the H in the ionic exchange group of the terminal end of the proton-conductive polymer side chain is substituted with Na or tetrabutylammonium, NaOH or tetrabutylammonium hydroxide may be used, respectively, during preparation of a catalyst composition. When the H is substituted with K, Li, or Cs, suitable compounds for the substitutions may be used. A method of substituting H is known in the related art, and therefore is not further described in detail.

The binder resins may be used singularly or in combinations. They may be used along with non-conductive polymers to improve adherence with a polymer electrolyte membrane. The binder resins may be used in a controlled amount as needed.

Non-limiting examples of the non-conductive polymers include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE), chlorotrifluoroethylene-ethylene copolymers (ECTFE), polyvinylidenefluoride, polyvinylidenefluoride-hexafluoropropylene copolymers (PVdF-HFP), dodecylbenzenesulfonic acid, sorbitol, and combinations thereof.

The electrode substrate plays a role of supporting an electrode, and also of spreading a fuel and an oxidant to a catalyst layer to help the fuel and oxidant to easily approach the catalyst layer.

As for the electrode substrate, a conductive substrate is used, for example carbon paper, carbon cloth, carbon felt, or metal cloth (a porous film including a metal cloth fiber or a metalized polymer fiber), but it is not limited thereto.

The electrode substrate may be treated with a fluorine-based resin to be water-repellent, which can prevent deterioration of reactant diffusion efficiency due to water generated during a fuel cell operation. The fluorine-based resin includes polytetrafluoroethylene, polyvinylidene fluoride, polyhexafluoropropylene, polyperfluoroalkylvinylether, polyperfluorosulfonylfluoridealkoxyvinyl ether, fluorinated ethylene propylene, polychlorotrifluoroethylene, a fluoroethylene polymer, or copolymers thereof.

A micro-porous layer (MPL) can be added between the electrode substrate and catalyst layer to increase reactant diffusion effects. In general, the microporous layer may include, but is not limited to, a small-sized conductive powder such as a carbon powder, carbon black, acetylene black, activated carbon, carbon fiber, fullerene, nano-carbon, or a combination thereof. The nano-carbon may include a material such as carbon nanotubes, carbon nanofiber, carbon nanowire, carbon nanohorns, carbon nanorings, or combinations thereof.

The microporous layer is formed by coating a composition including a conductive powder, a binder resin, and a solvent on the conductive substrate. The binder resin may include, but is not limited to, polytetrafluoroethylene (PTFE), polyvinylidene fluoride, polyhexafluoropropylene, polyperfluoroalkylvinylether, polyperfluorosulfonylfluoride, alkoxyvinyl ether, polyvinylalcohol, cellulose acetate, and copolymers thereof. The solvent may include, but is not limited to, an alcohol such as ethanol, isopropyl alcohol, ethyl alcohol, n-propyl alcohol, or butyl alcohol; water; dimethylacetamide (DMAc); dimethyl formamide; dimethyl sulfoxide (DMSO); N-methylpyrrolidone; or tetrahydrofuran. The coating method may include, but is not limited to, screen printing, spray coating, doctor blade methods, gravure coating, dip coating, silk screening, painting, and so on, depending on the viscosity of the composition.

A fuel cell system as an embodiment according to the principles of the present invention includes at least one electricity generating element, a fuel supplier, and an oxidant supplier.

The electricity generating element includes a membrane-electrode assembly that includes a polymer electrolyte membrane, a cathode and an anode positioned at both sides of the polymer electrolyte membrane, and separators positioned at both sides of the membrane-electrode assembly. The electricity generating element generates electricity through oxidation of a fuel and reduction of an oxidant.

The fuel supplier plays a role of supplying the electricity generating element with a fuel including hydrogen and the oxidant supplier plays a role of supplying the electricity generating element with an oxidant. The fuel includes liquid or gaseous hydrogen, or a hydrocarbon-based fuel such as methanol, ethanol, propanol, butanol, or natural gas. The oxidant includes oxygen or air. The fuel cell system is adapted to a direct oxidation fuel cell system where a hydrocarbon fuel is used.

In particular, the fuel cell system can suppress cross-over of a fuel while not decreasing proton conductivity even though methanol is used for a fuel.

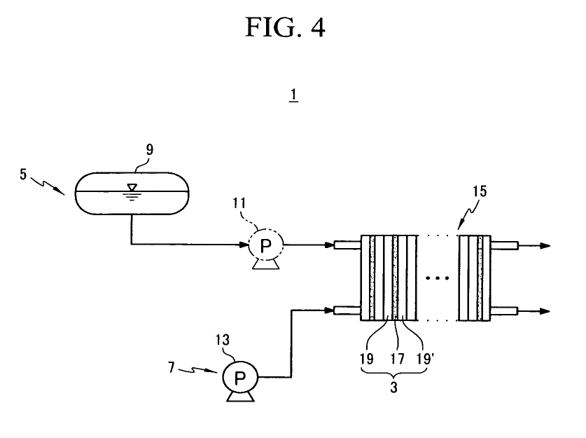

FIG. 4 shows a schematic structure of a fuel cell system 1 that will be described in detail with reference to this accompanying drawing, as follows. FIG. 4 illustrates a fuel cell system 1 wherein a fuel and an oxidant are provided to electricity generating element 3 through pumps 11 and 13, respectively. But the present invention is not limited to such a structure. The fuel cell system of the present invention may alternatively include a structure wherein a fuel and an oxidant are provided in a diffusion manner.

Fuel cell system 1 includes at least one electricity generating element 3 that generates electrical energy through an electrochemical reaction of a fuel and an oxidant, a fuel supplier 5 for supplying a fuel to the electricity generating element 3, and an oxidant supplier 7 for supplying an oxidant to electricity generating element 3.

In addition, fuel supplier 5 is equipped with a tank 9 that stores the fuel, and a fuel pump 11 that is connected therewith. Fuel pump 11 supplies the fuel stored in tank 9 with a predetermined pumping power.

Oxidant supplier 7, which supplies electricity generating element 3 with an oxidant, is equipped with at least one pump 13 for supplying the oxidant with a predetermined pumping power.

Electricity generating element 3 includes a membrane-electrode assembly 17 that oxidizes hydrogen or a fuel and reduces an oxidant, and separators 19 and 19′ that are respectively positioned at opposite sides of membrane-electrode assembly 17 and supply hydrogen or a fuel, and an oxidant, respectively. At least one electricity generating element 3 constitutes stack 15.

The following examples illustrate the present invention in more detail. However, it is understood that the present invention is not limited by these examples.

### EXAMPLE 1

A powdery silicic acid-based clay material of silicon oxide mixed with sodium oxide (mole ratio of SiO₂/Na₂O of 2.07) was fired at 600° C. to synthesize Na₂Si₂O₅. The synthesized Na₂Si₂O₅ was mixed with water in a weight ratio of 20:80 to synthesize a kanemite using a mechanical agitator. The provided kanemite was added into 1-butanol at a weight ratio of 20:80 to provide a mineral additive solution, and it was agitated with an agitator at room temperature for 24 hours.

The agitated mineral additive solution was allowed to stand for 7 days to precipitate the powders and to separate the supernatant, and the mineral additive solution was then dried under the room pressure condition to provide a single-layered kanemite in which a plurality of layers were exfoliated.

The aspect ratio of the kanemite was 600 to 800.

A commercially available perfluorosulfonate resin solution (Solution Technology, 5 wt % Nafion/H₂O/2-Propanol, EW 1100), dissolved in water and 2-propanol, was enforced to evaporate at room temperature, then the evaporated perfluorosulfonate resin was added into dimethyl acetamide (DMA) at a concentration of 5 parts by weight, agitated at 25° C. for 24 hours, to provide a cation exchange resin solution.

The provided single-layered kanemite was added into the provided cation exchange resin solution and mechanically agitated to uniformly disperse the same. The kanemite was added at 1 part by weight based on 100 parts by weight of the cation exchange resin solution.

The mixed solution in which the cation exchange resin was mixed with the kanemite was cast on a glass substrate and dried at 80° C. to provide a polymer electrolyte membrane for a fuel cell.

The provided polymer electrolyte membrane had an overall thickness of 50 μm, and the mineral additive was exfoliated in a nano-size and was dispersed in a single-layered structure in a polymer electrolyte membrane. The ratio of the mineral additives to the cation exchange resin was 1 part by weight based on 100 parts by weight of the cation exchange resin.

### EXAMPLE 2

A polymer electrolyte membrane was provided in accordance with the same procedure as in Example 1, except that the mineral additive was present at 3 parts by weight based on 100 parts by weight of the cation exchange resin.

### EXAMPLE 3

A polymer electrolyte membrane was provided in accordance with the same procedure as in Example 1, except that a commercially available makatite was used.

The provided polymer electrolyte membrane had an overall thickness of 50 μm, and the mineral additive was exfoliated in a nano-size and was dispersed in a single-layered structure in a polymer electrolyte membrane. The ratio of the mineral additives to the cation exchange resin in the polymer electrolyte membrane was 1 part by weight based on 100 parts by weight of the cation exchange resin.

### EXAMPLE 4

A polymer electrolyte membrane was provided in accordance with the same procedure as in Example 1, except that a commercially available kenyatite was used.

The provided polymer electrolyte membrane had an overall thickness of 50 μm, and the mineral additive was exfoliated in a-nano-size and was dispersed in a single-layered structure in a polymer electrolyte membrane. The ratio of the mineral additives to the cation exchange resin in the polymer electrolyte membrane was 3 parts by weight based on 100 parts by weight of the cation exchange resin.

### COMPARATIVE EXAMPLE 1

A commercially available perfluorosulfonate resin solution (Solution Technology, 5 wt % Nafion/H₂O/2-Propanol, EW 1100), dispersed in water and 2-propanol, was cast to make a membrane for a polymer electrode membrane.

### COMPARATIVE EXAMPLE 2

A powdery silicic acid-based clay material of silicon dioxide mixed with sodium oxide (SiO₂/Na₂O had a mole ratio of 2.07) was fired at 600° C. to synthesize Na₂Si₂O₅, and the synthesized Na₂Si₂O₅ was mixed with water at a weight ratio of 20:80 and mechanically agitated to provide a kanemite in which a plurality of layers were laminated and not exfoliated. Subsequently, the kanemite was mixed with a cation exchange resin to provide a polymer electrolyte membrane.

The polymer electrolyte membrane had an overall thickness of 50 μm, and the mineral additives were dispersed in a multi-layered structure in a polymer electrolyte membrane. The ratio the mineral additive was 3 parts by weight based on 100 parts by weight of the cation exchange resin in the prepared polymer electrolyte membrane.

X-ray Diffraction Peak Measurement of Polymer Electrolyte Membrane

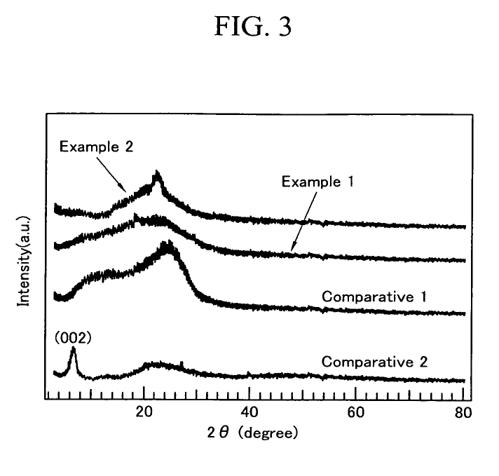

An X-ray diffraction peak was measured to find whether the cation exchange resin and the mineral additive were uniformly dispersed in the polymer electrolyte membranes according to Examples 1 and 2 and Comparative Examples 1 and 2, and the results are shown in FIG. 3.

The X-ray diffraction peaks were measured based on a CuKαray (λ=1.5406 Å) with an X-ray diffractometer (Phillips, X'pert Pro X-ray). As shown FIG. 3, peaks of (002) crystalline face corresponded to crystalline peaks of un-exfoliated kanemite, makatite, and kenyatite. The (002) crystalline peaks disappeared since a nano-size plate-shape mineral additive was present after being exfoliated. The mineral additive having a multi-layered structure was exfoliated to having a nano-sized plate-shape. Furthermore, since X-ray diffraction peaks had similar shapes regardless of whether a mineral additive was added or not and regardless of the amount thereof, the crystallinity of the polymer electrolyte membrane was not changed depending upon the addition of the mineral additive.

Methanol Permeability Measurement

Methanol permeability was measured at 30° C. depending upon the methanol concentration for polymer electrolyte membranes according to Example 1, Example 2, Comparative Example 1, and Comparative Example 2, and the results are shown in the following Table 1.

TABLE 1

| | Methanol permeability (×10⁻⁶ cm²S⁻¹) | | | |
|---|---|---|---|---|
| Methanol | | | Comparative | Comparative |
| concentration (M) | Example 1 | Example 2 | Example 1 | Example 2 |
| 1 | 0.52 | 0.50 | 2.00 | 1.10 |
| 3 | 0.63 | 0.62 | 2.17 | 1.20 |
| 5 | 0.72 | 0.71 | 2.40 | 1.35 |
| 10 | 0.82 | 0.83 | 2.62 | 1.50 |

As shown in Table 1, the methanol permeability of the polymer electrolyte membrane according to Example 1 is significantly lower than that of Comparative Example 1. The polymer electrolyte membranes according to Examples 1 and 2 had lower methanol permeability than that of Comparative Example 2 including the multi-layered mineral additive that was not exfoliated. From the result, it is confirmed that the mineral additives according to Examples 1 and 2 could prevent the passage of methanol through the polymer electrolyte membrane.

Furthermore, the amount of mineral additive according to Example 1 was 1 part by weight based on 100 parts by weight of the cation exchange resin, and the amount of mineral additive according to Example 2 was 3 parts by weight based on 100 parts by weight of the cation exchange resin. The mineral additives according to Examples 1 and 2 could prevent the passage of methanol even when used in a small amount.

Proton Conductivity Measurement

Proton conductivity was measured depending upon the driving temperature for polymer electrolyte membranes according to Example 1, Example 2, Comparative Example 1, and Comparative Example 2, and the results are shown in following Table 2.

TABLE 2

| | Proton conductivity (S/cm) | | | |
|---|---|---|---|---|
| | | | Comparative | Comparative |
| Temperature (° C.) | Example 1 | Example 2 | Example 1 | Example 2 |
| 50 | 0.212 | 0.202 | 0.061 | 0.132 |
| 60 | 0.225 | 0.206 | 0.122 | 0.141 |
| 70 | 0.232 | 0.213 | 0.135 | 0.165 |
| 80 | 0.244 | 0.225 | 0.149 | 0.183 |
| 100 | 0.261 | 0.246 | — | 0.212 |

(— denotes measurement incapability)

As shown in Table 2, polymer electrolyte membranes according to Examples 1 and 2 showed suitable proton conductivity in the driving temperature range. In the polymer electrolyte membrane in which the mineral additive was added according to one embodiment, the fuel cell cross-over was prevented and the conductivity was not deteriorated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A polymer electrolyte membrane for a fuel cell, comprising:
a cation exchange resin; and
a mineral additive including an exfoliated layered silicic acid-based clay.

2. The polymer electrolyte membrane of claim 1, comprised of the mineral additive comprising at least one selected from the group consisting of kanemite, makatite, octasilicate, kenyatite, and mixtures thereof.

3. The polymer electrolyte membrane of claim 1, comprised of the mineral additive being dispersed in a nano-sized plate-shaped structure in the polymer electrolyte membrane.

4. The polymer electrolyte membrane of claim 1, comprised of the mineral additive having an aspect ratio ranging from approximately 200 to 2500.

5. The polymer electrolyte membrane of claim 1, comprised of the mineral additive being present in an amount of 0.5 to 3 parts by weight based on 100 parts by weight of the cation exchange resin.

6. The polymer electrolyte membrane of claim 1, comprised of the cation exchange resin being a polymer resin having a cation exchange group selected from the group consisting of a sulfonic acid group, a carboxylic acid group, a phosphoric acid group, a phosphonic acid group, and derivatives thereof at its side chain.

7. The polymer electrolyte membrane of claim 6, comprised of a polymer in the polymer resin comprising at least one proton conductive polymer selected from the group consisting of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof.

8. A method for manufacturing a polymer electrolyte membrane for a fuel cell, comprising:
preparing a mineral additive composition by adding a mineral additive to an organic solvent;
agitating the mineral additive composition to exfoliate the mineral additive;
separating the mineral additive from the mineral additive composition; and
mixing the separated mineral additive and a cation exchange resin.

9. The method of claim 8, comprised of the agitating being performed at a speed of approximately 300 rpm to 2000 rpm.

10. The method of claim 8, comprised of the mineral additive being used in an amount of approximately 10 to 25 parts by weight based on 100 parts by weight of the organic solvent.

11. The method of claim 8, comprised of the organic solvent comprising at least one selected from the group consisting of an alcohol-based solvent, a furan-based solvent, and mixtures thereof.

12. The method of claim 8, comprised of the exfoliated mineral additive having a nano-sized plate-shaped structure.

13. The method of claim 8, comprised of the mineral additive being present in an amount of approximately 0.5 to 3 parts by weight based on 100 parts by weight of the cation exchange resin.

14. The method of claim 8, comprised of the mineral additive having an aspect ratio ranging from approximately 200 to 2500.

15. The method of claim 8, comprised of the cation exchange resin being a polymer resin having a cation exchange group selected from the group consisting of a sulfonic acid group, a carboxylic acid group, a phosphoric acid group, a phosphonic acid group, and derivatives thereof at its side chain.

16. The method of claim 15, comprised of the polymer resin comprising at least one proton conductive polymer selected from the group consisting of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof.

17. A membrane-electrode assembly for a fuel cell, comprising:
an anode and a cathode facing each other; and
a polymer electrolyte membrane interposed between the anode and cathode, with the polymer electrolyte membrane comprising:
a cation exchange resin; and
a mineral additive including an exfoliated layered silicic acid-based clay.

18. The membrane-electrode assembly of claim 17, comprised of the mineral additive comprising at least one selected from the group consisting of kanemite, makatite, octasilicate, kenyatite, and mixtures thereof.

19. The membrane-electrode assembly of claim 17, comprised of the mineral additive being dispersed in a nano-sized plate-shaped structure in a polymer electrolyte membrane.

20. The membrane-electrode assembly of claim 17, comprised of the mineral additive having an aspect ratio ranging from approximately 200 to 2500.

21. The membrane-electrode assembly of claim 17, comprised of the mineral additive being present in an amount of approximately 0.5 to 3 parts by weight based on 100 parts by weight of the cation exchange resin.

22. A fuel cell system, comprising:
an electricity generating element comprising:
a membrane-electrode assembly, comprising:
an anode and a cathode facing each other; and
a polymer electrolyte membrane interposed between the anode and cathode; and
a separator positioned at each side of the membrane-electrode assembly;
a fuel supplier that supplies the electricity generating element with a fuel; and
an oxidant supplier that supplies the electricity generating element with an oxidant, with the polymer electrolyte membrane comprising:
a cation exchange resin; and
a mineral additive including an exfoliated layered silicic acid-based clay.

23. The fuel cell system of claim 22, comprised of the mineral additive comprising at least one selected from the group consisting of kanemite, makatite, octasilicate, kenyatite, and mixtures thereof.

24. The fuel cell system of claim 22, comprised of the mineral additive being dispersed in a nano-sized plate-shaped structure in a polymer electrolyte membrane.

25. The fuel cell system of claim 22, comprised of the mineral additive having an aspect ratio ranging from approximately 200 to 2500.

26. The fuel cell system of claim 22, comprised of the mineral additive being present in an amount of approximately 0.5 to 3 parts by weight based on 100 parts by weight of the cation exchange resin.

27. The fuel cell system of claim 22, comprised of the mineral additive being exfoliated by agitating the mineral additive at a speed of approximately 300 to 2000 rpm.

28. The fuel cell system of claim 22, comprised of the fuel cell system being adapted to a direct oxidation fuel cell system.

29. The fuel cell system of claim 22, comprised of the fuel being a hydrocarbon fuel.

30. The fuel cell system of claim 22, comprised of the fuel being methanol.
